(19) United States
(12) Patent Application Publication
(10) Pub. No.: US 2004/0109525 A1
(43) Pub. Date: Jun. 10, 2004

(54) Automatic chip counting system (process)

(76) Inventor: Koc Vai Chieng aka Michael Chieng, Irvine, CA (US)

Correspondence Address: Koc Vai Chieng, 1 Alejo, Irvine, CA, 92612, US

(21) Appl. No.: 10/314,558

(22) Filed: Dec. 9, 2002

(51) Int. Cl. G06M 7/00

(52) U.S. Cl. 377/6

(57) ABSTRACT

The invention is a process of counting poker chips or similar tokens used in casino games or similar games and entertainment, which counts the chips in the columns of standard poker-chip trays by sending an ultrasonic (or other measurable energy) wave-front down the given column and measuring the time until an echo is received. If the length of the column is known, and the thickness of the standard poker chip is known, and the speed of sound is known, then the number of chips in the given column is determined by subtracting the current actually measured wave-front echo time from the empty column wave-front echo time and dividing by the amount of time the ultrasonic wave-front takes to traverse one chip-thickness.

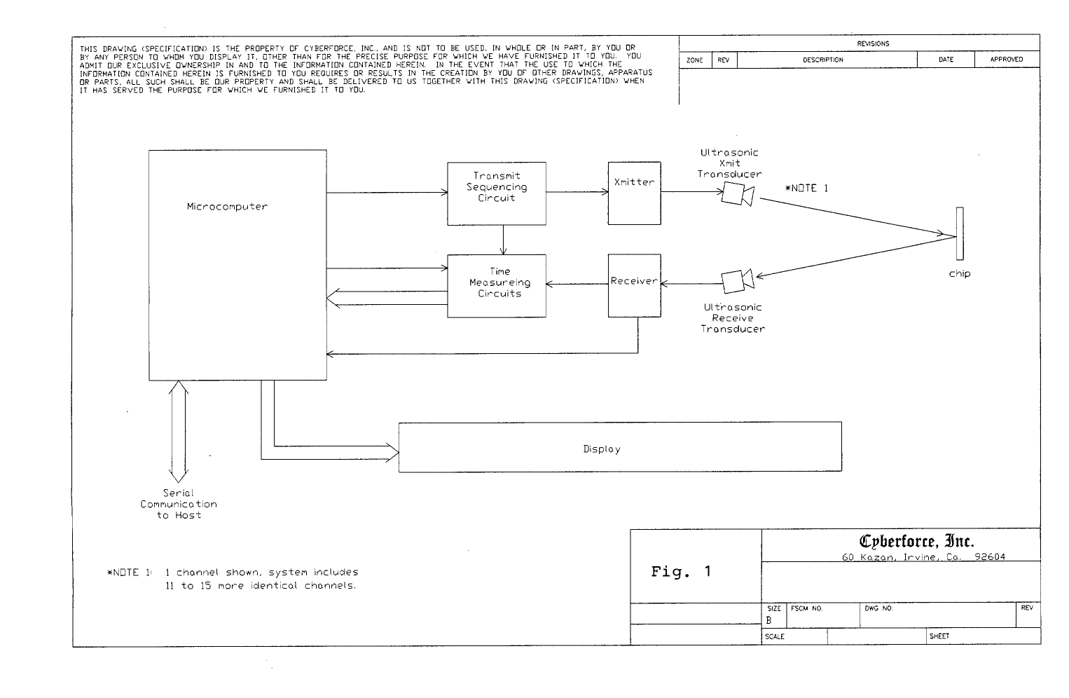

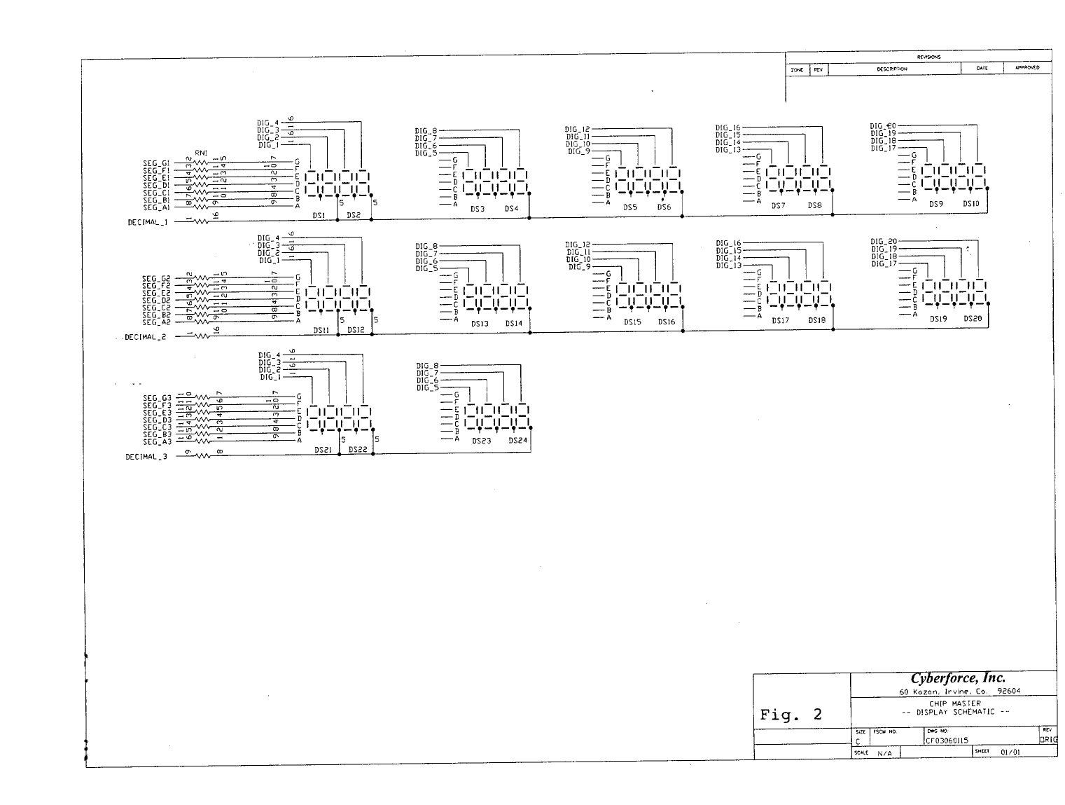

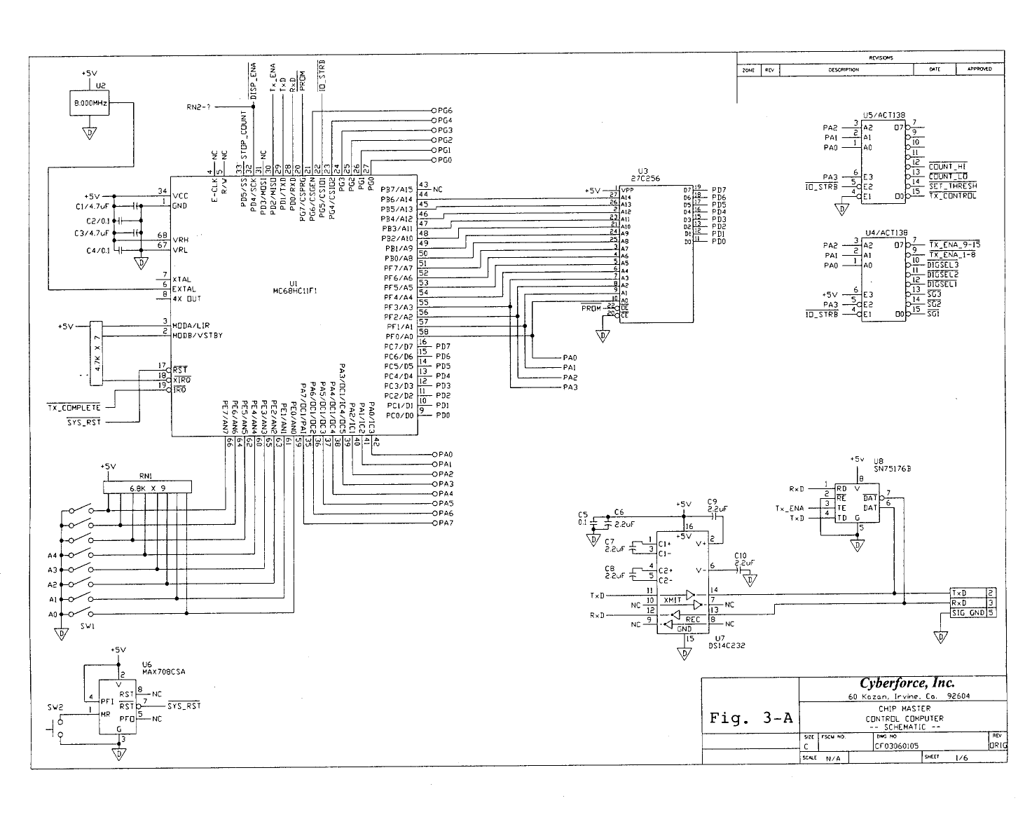

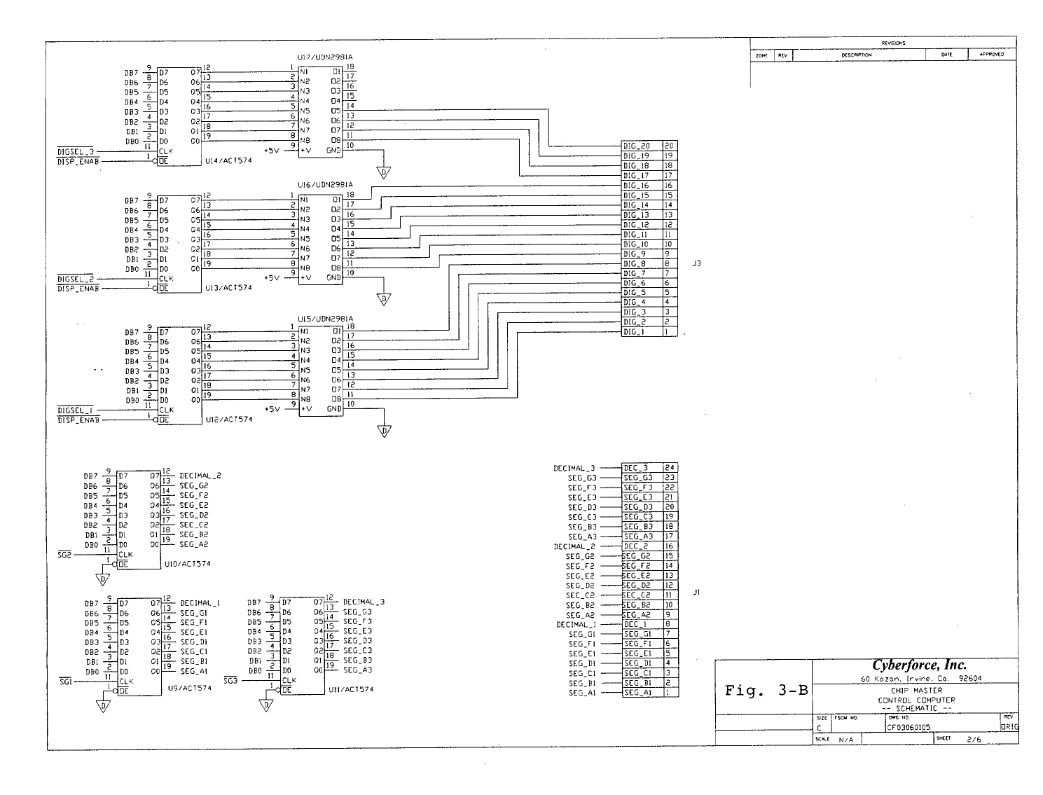

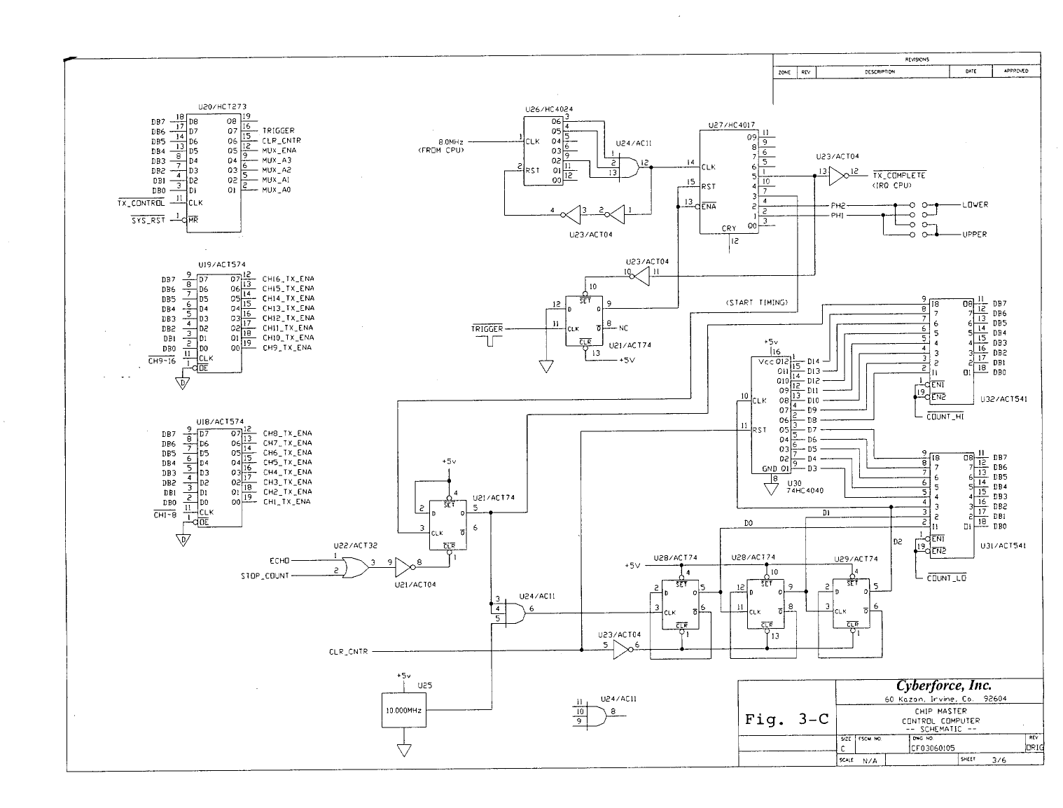

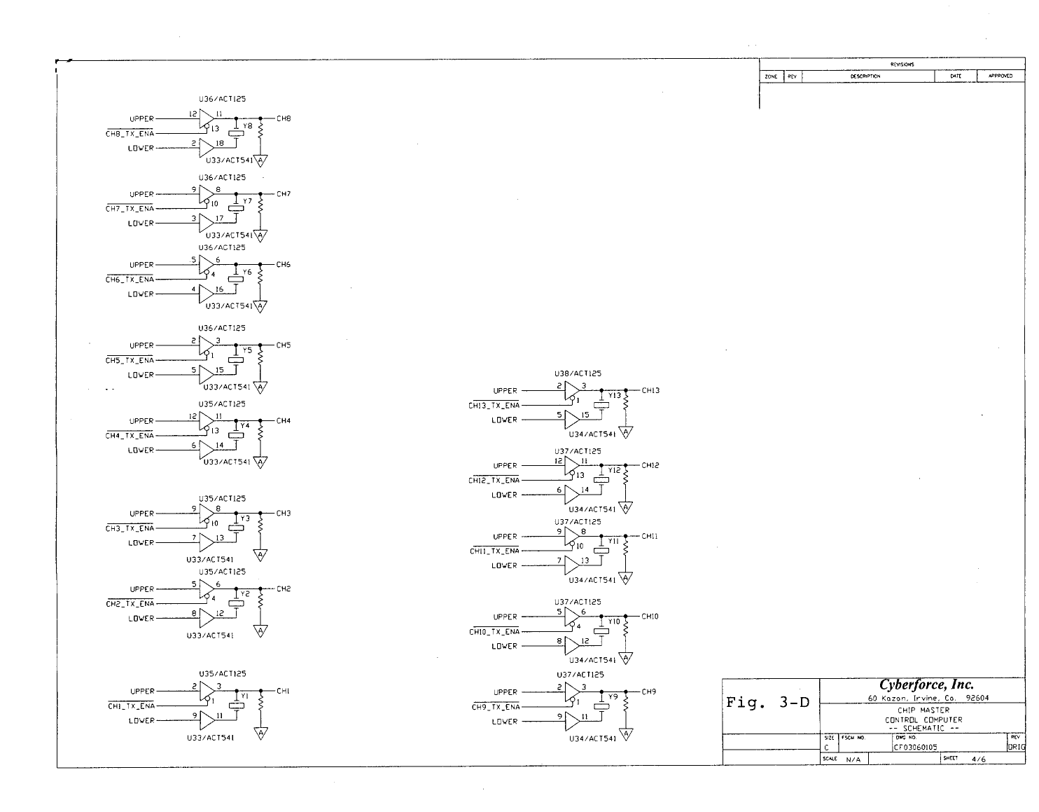

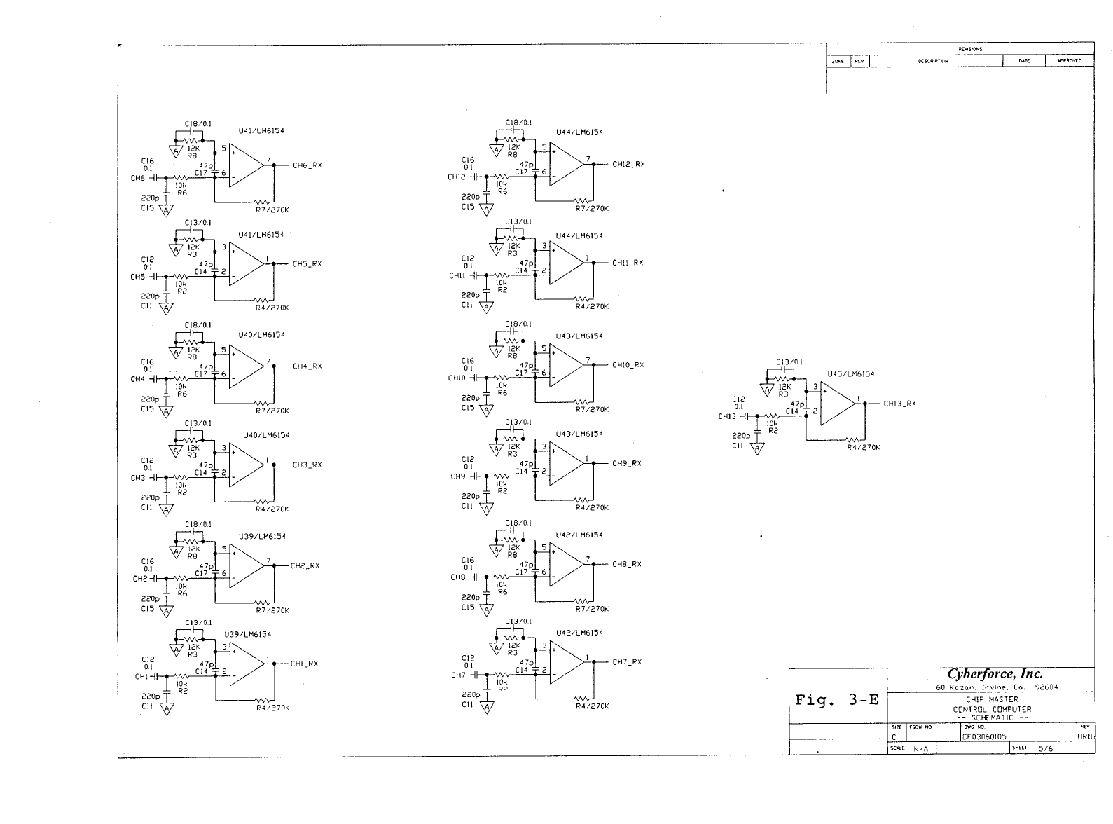

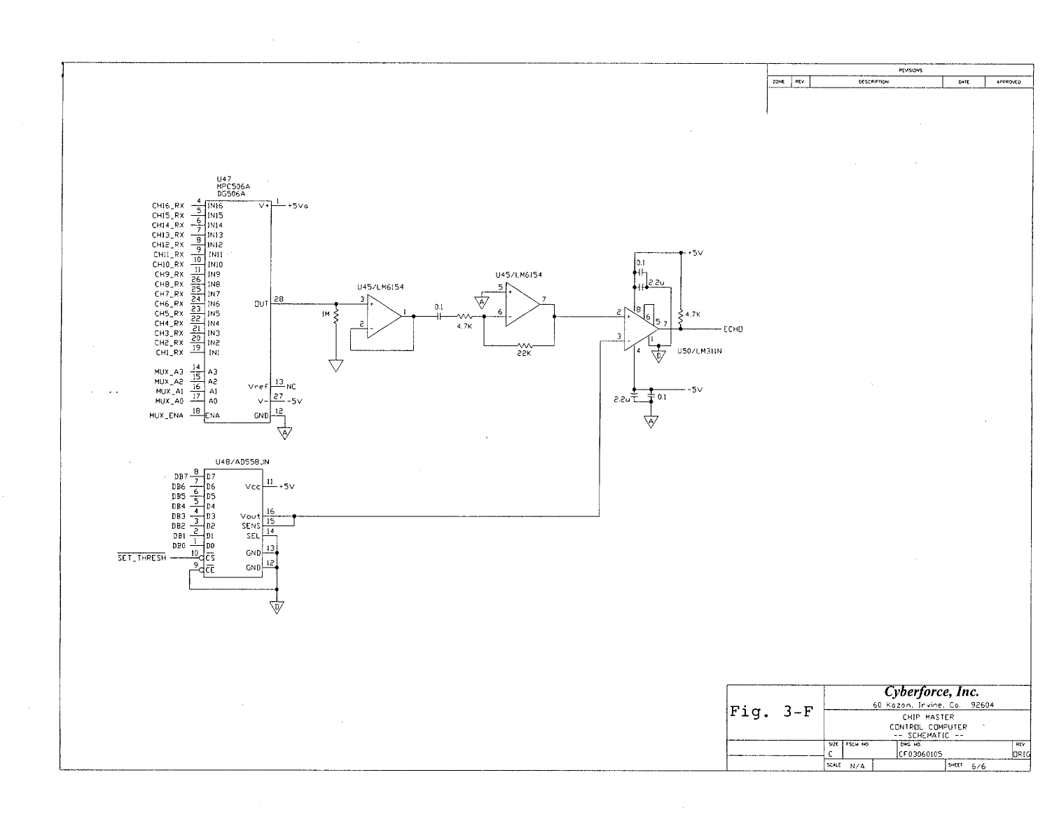

### SUMMARY OF THE INVENTION

The invention is a process of counting poker chips or similar tokens which counts the chips in the columns of standard poker-chip trays by sending an ultrasonic (or other measurable energy) wave-front down the given column and measuring the time until an echo is received. If the length of the column is known, and the thickness of the standard poker chip is known, and the speed of sound is known, the number of chips in the column can be determined by the following formula:

((reference-echo-time)−(measured-echo-time))/(chip-thickness-time)=number of chips

a) **(reference-echo-time) is the empty column echo time.

b) **(chip-thickness-time) is the amount of time the ultrasonic wave-front takes to traverse one chip-thickness.

c) **(measured-echo-time) is the echo-time for the current actual measurement.

### DESCRIPTION

The counter uses electronic circuits to generate and route a single cycle of a 40 KHz signal to an ultrasonic sending transducer which creates the wave-front and sends it down the column of the chip-tray. Simultaneously a time-measuring circuit is initiated. This wave-front will hit either a poker chip or the back wall of the column and reflect back (echo) toward the sending transducer. An ultrasonic receiving transducer is mounted immediately above the sending transducer. The receiving transducer converts the energy of the reflected wave-front to an electronic signal which freezes the time-measuring circuits and alerts the controlling microcomputer that the echo-time is captured. The microcomputer performs the calculation described above, converts the chip-count to dollars and saves the dollar-value in its memory.

This sequence of events occurs for each column of the chip tray in a round-robin fashion, continuously. When so commanded, the microcomputer collects the saved dollar values from memory and displays them on the built-in display and/or sends them out of a serial port to a host computer.

### DRAWINGS

Attached are eight Figures showing the scheme of the counting process. FIG. One depicts the schematic counter system. FIGS. Two through Eight depict the schematic chip master control computer.

The following single claim is made:

1. A method of counting chips or tokens in games and entertainment comprising the steps of:
using electronic circuits to generate and route a single cycle of a 40 KHz signal to an ultrasonic sending transducer which creates the wave-front and send it down the given column of the chip-tray, where simultaneously a time-measuring circuit is initiated so that this wave-front will hit either a poker chip/token or the back wall of the column and reflect back toward the sending transducer, and then where the receiving transducer converts the energy of the reflected wave-front to an electronic signal which freezes the time-measuring circuits and also alerts the controlling microcomputer that the echo-time of wave-front sent and received is captured, and where the microcomputer performs the calculation and saves the dollar-value in memory, so that if and when commanded said microcomputer gathers the saved dollar-values from its memory and displays these values on a built-in display or else sends them out a serial port to the host computer.
